(19) United States
(12) Patent Application Publication
(10) Pub. No.: US 2010/0141226 A1
(43) Pub. Date: Jun. 10, 2010

(54) Switching power circuit and power supply method

(75) Inventors: Hiroyuki Hongou, Toyokawa-city (JP); Takamasa Oguri, Tokyoake-city (JP); Takeshi Miki, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/591,698

(22) Filed: Nov. 30, 2009

(30) Foreign Application Priority Data
Dec. 4, 2008 (JP) 2008-309650

(51) Int. Cl. G05F 1/10

(52) U.S. Cl. 323/282

(57) ABSTRACT

A switching power circuit is provided with a power bypass circuit. The bypass circuit supplies a power supply voltage of an input terminal by bypassing a FET and a π-filter during a period after supply of the power supply voltage is started until the power supply voltage reaches a predetermined threshold level corresponding to a reference voltage. Even if start of the switching operation of the FET is delayed because of the operation of a soft start circuit, the power supply voltage supplied to a load through the switching power circuit is raised at earlier time.

### CROSS REFERENCE TO RELATED APPLICATION

This application is based on and incorporates herein by reference Japanese Patent Application No. 2008-309650 filed on Dec. 4, 2008.

### FIELD OF THE INVENTION

The present invention relates to a switching power circuit and a power supply method for outputting an output voltage by switching on and off and smoothing a power supply voltage supplied from an external power source.

### BACKGROUND OF THE INVENTION

In a conventional switching power circuit for a vehicle, for example, as shown in FIG. 10, a power supply voltage +B (12V, for example) of a battery (not shown) is supplied to a power input terminal VIN of a switching power integrated circuit (IC) 1 from an external side and a switching input terminal SWIN of the same. The power input terminal VIN is grounded through a capacitor 3, which is externally connected to a current source 2 and a C-terminal. The C-terminal is connected to the non-inverting input terminal of a comparator 4. A predetermined reference voltage Vref1 of a reference voltage generator circuit 5 is applied to the inverting input terminal of the comparator 4. The output terminal of the comparator 4 is connected to an input terminal of a driver circuit 6.

The switching input terminal SWIN is connected to the drain of a N-channel MOSFET 7. The gate of FET 7 is connected to the output terminal of the driver circuit 6. A carrier wave (for example, a triangular wave of a frequency of about several tens of kHz), which is outputted by an oscillator circuit 8 and a triangular signal generator circuit 9 and PWM-controlled, is applied to the driver circuit 6. The driver circuit 6 generates a PWM signal by comparing the voltage level of the carrier wave with a PWM control command described below and outputs it to the gate of FET 7 as a switching control signal.

The source of FET 7 is connected to a switching output terminal SWOUT, to which a diode 10 and a π-filter 14 is connected at the external part of IC 1. The π-filter 14 is configured with a coil 11 and capacitors 12, 13. The anode and the cathode of the diode 10 are grounded and connected to the coil 11, respectively. The output side of the π-filter 14 is connected to the non-inverting input terminal of a comparator 15 through a switching power input terminal SWPIN in IC 1. The reference voltage Vref1 is applied from the reference voltage generator circuit 5 to the inverting input terminal of the comparator 15. An output signal of the comparator 15 is applied to the driver circuit 6 as the PWM control command.

The input terminal SWPIN is also connected to the drain of a N-channel

MOSFET 16 in IC 1. The source and gate of FET 16 is connected to a main power terminal VOM and the output terminal of a control circuit 17, respectively. The control circuit 17 monitors a level of a voltage of the main power terminal VOM by a detector circuit (not shown), and controls the on-period of FET 16 so that the voltage at the main power terminal VOM is regulated to a predetermined level, for example 5V. The input terminal SWPIN is pulled down by a resistor 18 connected externally. A power voltage outputted from the main power terminal VOM is supplied to, for example, a microcomputer as a control power voltage. In this IC 1, the current source 2, the capacitor 3, the comparator 4, the reference voltage generator circuit 5 forms a soft start circuit 19. IC 1, the capacitor 3, the diode 10 and the π-filter 14 form a switching power circuit 20.

The operation of the switching power circuit 20 is described next with further reference to FIG. 11.

When a power supply switch such as an ignition switch of a vehicle (not shown) is turned on and the power supply voltage +B is supplied from a battery (see (b) at time (1)), charging the capacitor 3 by a constant current of the current source 2 is started (see (c)). At time when the battery is connected (see (a)), the same voltage is supplied directly to the reference voltage generator circuit 5. As long as a terminal voltage of the capacitor 3 is lower than the reference voltage Vref1, the output signal of the comparator 4 is low and the driver circuit 6 keeps turning off FET 7.

When the terminal voltage of the capacitor 3 exceeds the reference voltage Vref1 (see (c) at time (2)), the output signal of the comparator 4 becomes high and the driver circuit 6 starts to output a gate signal (PWM signal) to FET 7 (see (e)). The power supply voltage +B supplied to the switching input terminal SWIN is thus switched on so that the potential at the input terminal SWPIN starts to increase (see (d)). The interval from time (1) to time (2), which corresponds to a soft start period, is set to about several tens of milliseconds (ms), for example. The control circuit 17 turns on and off FET 16 to decrease the voltage applied to the input terminal SWPIN after smoothing by the π-filter 14, so that the voltage level at the main power terminal VOM is regulated to a predetermined voltage (see (f)) lower than the power supply voltage +B. The switching power circuit 20 is similar to a power circuit, which is for example disclosed in U.S. Pat. No. 6,850,047 (JP 2004-173481A).

As described above, if the switching power circuit 20 is provided with the soft start circuit 19 for delaying the start of the switching operation of FET 7 at the time of turning on supply of the electric power, the time point at which the voltage level at the main power terminal VOM rises is delayed correspondingly by such a delay period. As a result, the time point at which a microcomputer is released from the power-on reset condition is also delayed, thus causing delay in the start-up of the microcomputer.

### SUMMARY OF THE INVENTION

It is therefore an object of the present invention to provide a switching power circuit and a power supply method, which are capable of raising its output terminal voltage even in case a soft start function is provided.

According to one .aspect of the present invention, a switching power circuit is provided with an electric power supply path, a switching section, a smoothing section and a control signal generator section, a soft start section and a power bypass section. The electric power supply path connects an output terminal and an input terminal, to which a power supply voltage is supplied from an external side. The switching section is interposed in the current supply path to switch on and off the power supply voltage. The smoothing section smoothes a switching output voltage produced by a switching operation of the switching section and produces an output terminal voltage, which is supplied to the output terminal. The control signal generator section generates a control signal to control the switching section so that the output terminal voltage produced by the smoothing section is regulated to a predetermined level. The soft start section starts the switching operation of the switching section after an elapse of a predetermined period from a start of supply of the power supply voltage to the input terminal. The power bypass section supplies the power supply voltage to the output terminal by bypassing the switching section and the smoothing section until the power supply voltage reaches a predetermined reference voltage after the start of supply of the power supply voltage to the input terminal.

According to another aspect of the present invention, a method of producing an output power voltage to an output terminal from a power supply voltage supplied to an input terminal is provided. In this method, charging a capacitor is started when supply of the power supply voltage to the input terminal is started. A voltage of the capacitor is compared with a reference voltage. A switching operation of a switching section is started in correspondence to the output power voltage at the output terminal when a result of comparison indicates that the voltage of the capacitor has reached the reference voltage. The switching section produces a switching output voltage intermittently from the power supply voltage in correspondence to the switching operation. The switching output voltage is smoothed to produce the output power voltage at the output terminal. The power supply voltage is supplied directly to the output terminal when the supply of the power supply voltage to the input terminal is started, so that the switching section starts the switching operation before the voltage of the capacitor reaches the reference voltage.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing a switching power circuit according to the first embodiment of the present invention;

FIG. 2 is a signal diagram showing signals developed in the first embodiment;

FIG. 3 is a circuit diagram showing a switching power circuit according to the second embodiment of the present invention;

FIG. 4 is a circuit diagram showing a switching power circuit according to the third embodiment of the present invention;

FIG. 5 is a circuit diagram of a switching power circuit according to the fourth embodiment of the present invention;

FIG. 6 is a circuit diagram of a switching power circuit according to the fifth embodiment of the present invention;

FIG. 7 is a circuit diagram of a switching power circuit according to the sixth embodiment of the present invention;

FIG. 8 is a circuit diagram of a switching power circuit according to the seventh embodiment of the present invention;

FIG. 9 is a circuit diagram of a switching power circuit according to the eighth embodiment of the present invention;

FIG. 10 is a circuit diagram showing a conventional switching power circuit; and

FIG. 11 is a signal diagram showing signals developed in the conventional switching power circuit.

### DETAILED DESCRIPTION OF THE PREFERRED EMBODIMENT

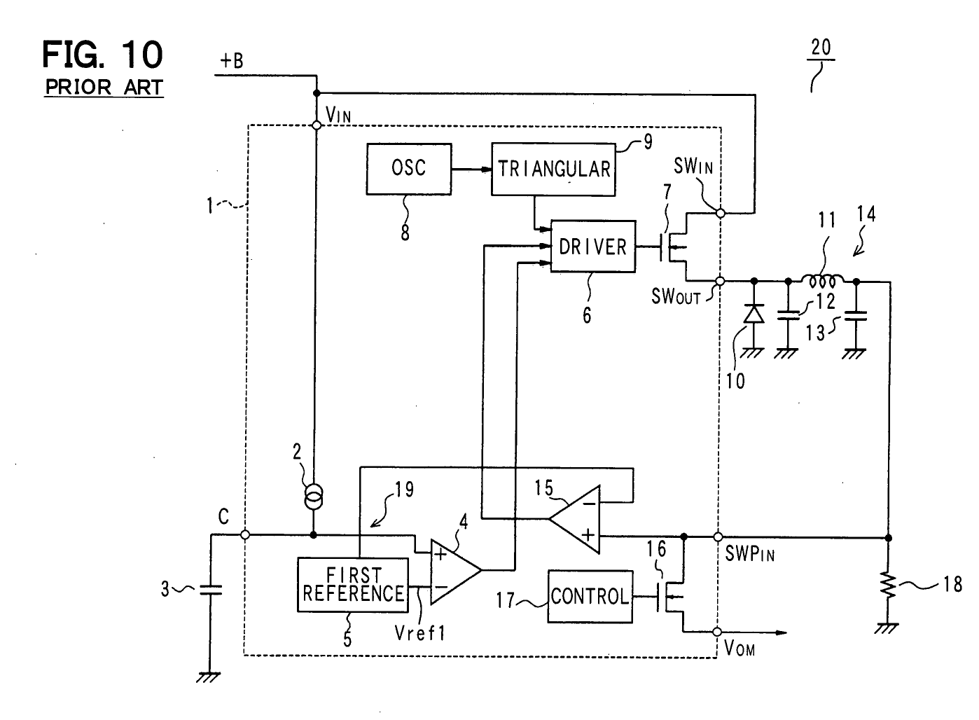

The present invention will be described in detail with respect to various embodiments, in which the same or similar parts as in the conventional circuit shown in FIG. 10 or in other embodiments are denoted by the same or reference numerals, thereby omitting the same or similar description.

### First Embodiment

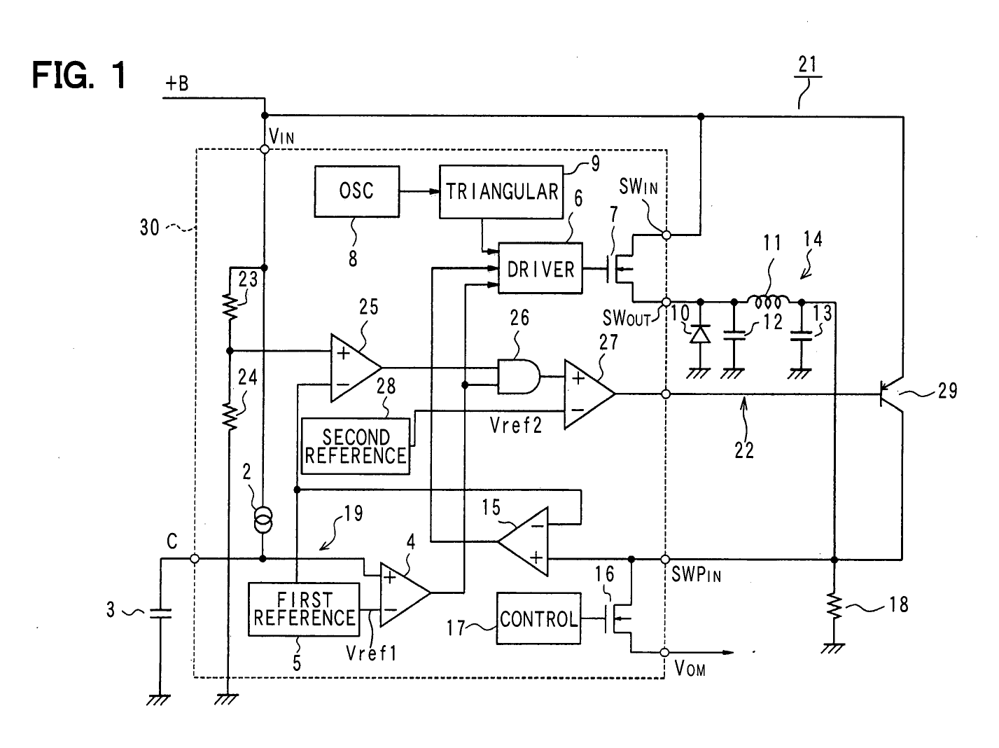

Referring to FIG. 1, a switching power circuit 21 according to the first embodiment is provided with a power bypass circuit (power bypass section) 22 in addition to the conventional switching power circuit 20. In the power bypass circuit 22, a series circuit of resistors 23 and 24 is connected between the input terminal VIN and the ground. The common junction between the resistors 23 and 24 is connected to the non-inverting input terminal of a comparator 25. The inverting input terminal of the comparator 25 is connected to receive the reference voltage Vref1 from the reference voltage generator circuit 5.

The output terminal of the comparator 25 is connected to one input terminal of an AND gate 26. The other input terminal of the AND gate 26 is connected to the output terminal of the comparator 4. The output terminal of the AND gate 26 is connected to a non-inverting input terminal of a comparator 27. The inverting input terminal of the comparator 27 is connected to receive a reference voltage Vref2 from a reference voltage generator circuit 28. The output terminal of the comparator 27 is connected to the base of a PNP transistor (bypass transistor) 29.

The comparator 27 is provided as a driver for driving the transistor 29. The reference voltage Vref2 is set to be equal to or higher than the reference voltage Vref1. The emitter of the transistor 29 is connected to receive the power supply voltage +B and the collector of the same is connected to the input terminal SWPIN. Thus, the bypass circuit 22 including the transistor 29 is connected in parallel relation to an electric power supply path, in which FET land the smoothing circuit 14 are interposed. All electronic circuits and components of the power bypass circuit 22 other than the transistor 29 are integrated in a switching power IC 30 together with the other circuits.

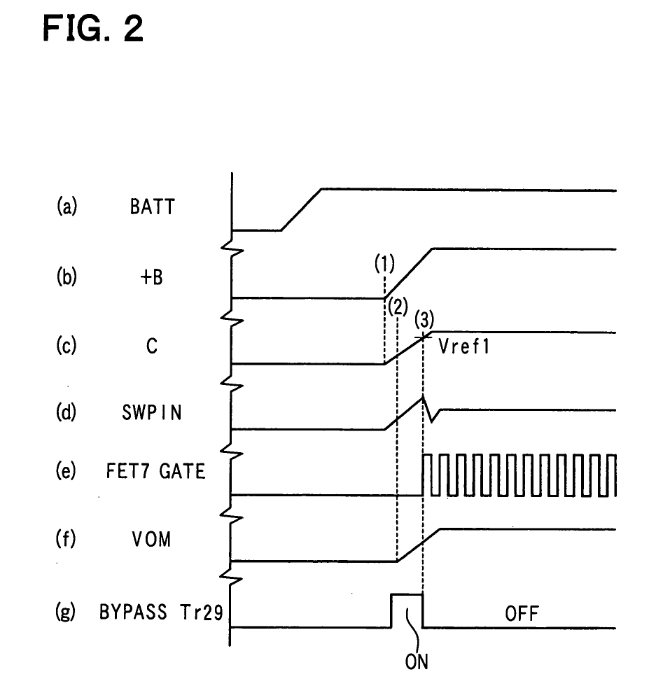

The operation of the first embodiment is described with further reference to FIG. 2.

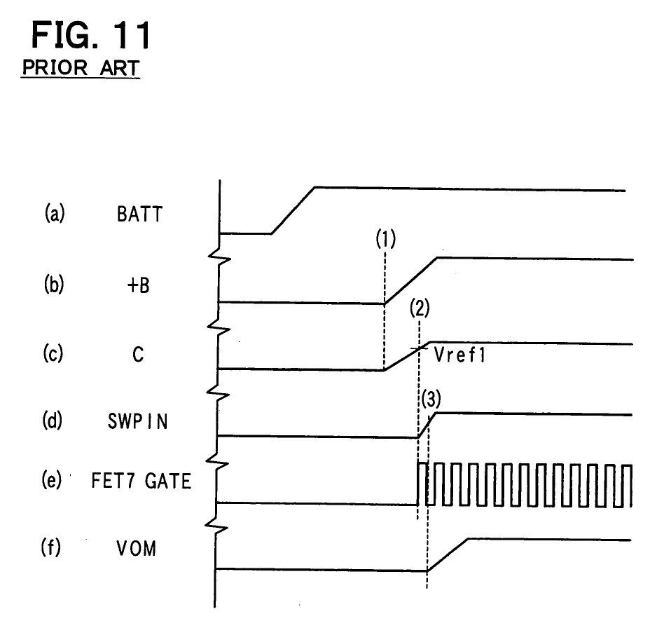

In the similar manner as the conventional operation shown in FIG. 11, when the power supply switch is turned on and the power supply voltage +B is supplied (see (b) at time (1)), charging the capacitor 3 is started (see (c)). The output levels of the comparators 4 and 25 are both low, and hence the output level of the AND gate 26 is also low. As a result, a base current flows in the transistor 29 and the transistor 29 is turned on (see (g)). The power supply voltage +B is supplied directly to the input terminal SWPIN through the transistor 29.

By the operation of the transistor 29, the potential of the input terminal SWPIN starts to rise at earlier time. The potential of the main power terminal VOM also starts to rise at earlier time correspondingly (see (f) at time (2)). In the course of rising of the power supply voltage +B, the potential at the non-inverting input terminal of the comparator 25 exceeds the reference voltage Vref1 earlier than at the comparator 4. However, the transistor 29 keeps turning on, because the comparator 4 keeps outputting the low level.

When the terminal voltage of the capacitor 3 exceeds the reference voltage Vref1 (see (c) at time (3)), the output, signal of the comparator 4 becomes high. The output signals of the AND gate 26 and the comparator 27 become high, so that the transistor 29 is turned off (see (g)). Since the driver circuit 6 starts outputting a gate signal to FET (switching section) 7 (see (e)) at this time, the switching output voltage produced intermittently by the switching operation of the FET 7 is supplied to the input terminal SWPIN (see (d)). The main power voltage VOM is produced in correspondence to the output voltage supplied to the switching power input terminal SWPIN.

The soft start period from time (1) to time (3) shown in FIG. 2 corresponds to the period from time (1) to time (2) shown in FIG. 11. The interval from time (1) to time (2) shown in FIG. 2 becomes shorter than the soft start period. The time (1) indicates the start of supply of the power supply voltage +B and the time (2) indicates the start of rise of the potential of the main power supply terminal VOM. Thus, according to the switching power circuit 21, the power voltage supplied to electric loads such as a microcomputer can rise at earlier time than in the conventional circuit 20.

If the power supply voltage +B falls for some reason after the voltage of the main power supply terminal VOM has once been stabilized, the potential of the non-inverting input terminal of the comparator 25 falls below the reference voltage Vref1 earlier than at the comparator 4. The output signal of the comparator 25 becomes low first and the transistor 29 is turned on by the AND gate 26 and the comparator 27. As a result, even if the power supply voltage +B temporarily falls after the power supply is started, the voltage of the main power terminal VOM rises at earlier time by the turn-on of the transistor 29.

According to the first embodiment, the switching power circuit 21 is provided with the power bypass circuit 22, which supplies the power supply voltage to the input terminal SWPIN by bypassing FET 7 and the π-filter (smoothing section) 14 during a period after supply of the power supply voltage is started until the power supply voltage +B reaches the predetermined threshold level corresponding to the reference voltage Vref1. As a result, even if starting of the switching operation of FET 7 is delayed because of the operation of the soft start circuit (soft start section) 19, the voltage of the main power supplied to loads such as a microcomputer through the switching power circuit 21 can be raised at earlier time.

The power bypass circuit 22 supplies the power supply voltage +B by bypassing FET 7 and the smoothing circuit until the power supply voltage +B reaches the predetermined threshold level, even when the power supply voltage +B falls below the threshold level corresponding to the reference voltage Vref1 after having been stabilized once. Therefore, delay in rise of voltage caused by the operation of the soft start circuit 19 can be reduced.

The power bypass circuit 22 renders the power supply path between the switching input terminal SWIN and the switching power input terminal SWPIN (output terminal of the power supply path) conductive by the transistor 29 in accordance with the output signal of the comparator 4, which compares the power supply voltage at the input terminal NIN as the terminal voltage of the capacitor 3 with the reference voltage Vref1 corresponding to the threshold level.

### Second Embodiment

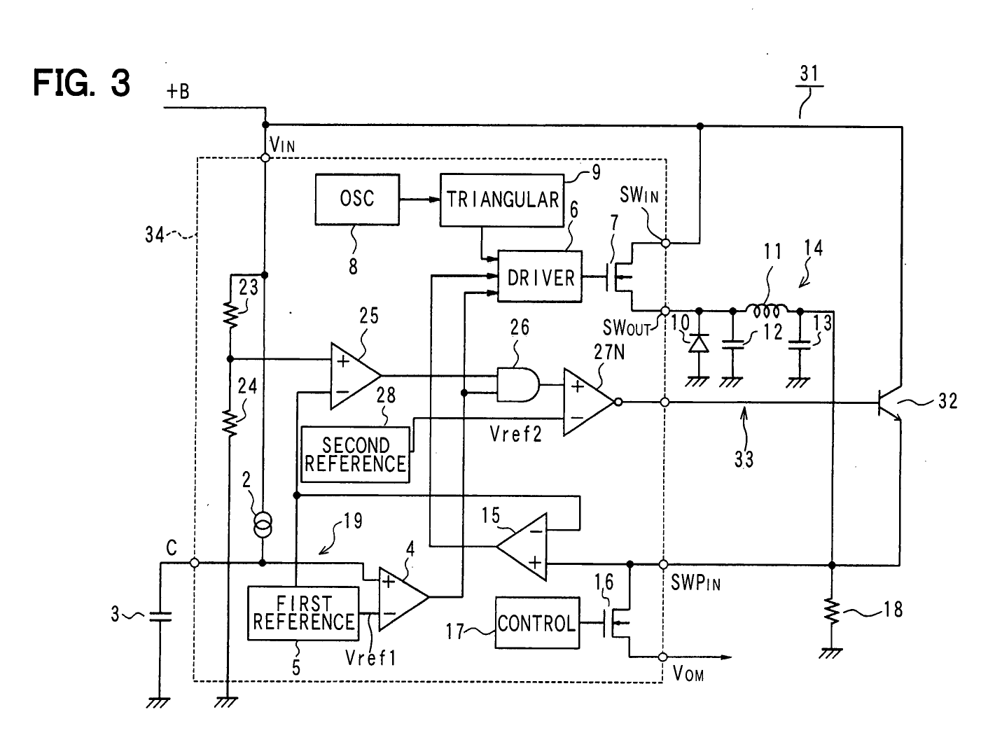

Referring to FIG. 3, a switching power circuit 31 according to the second embodiment is provided with a power bypass circuit (power bypass section) 33 in place of the power bypass circuit 22 of the first embodiment. In the power bypass circuit 33, a NPN transistor (bypass transistor) 32 is provided in place of the transistor 29. The collector of the transistor 32 is connected to receive the power supply voltage +B and the emitter of the same is connected to the input terminal SWPIN. A comparator 27N having an inverted-logic output terminal is provided in place of the comparator 27. The power bypass circuit 33 other than the transistor 32 is integrated into a switching power IC 34 together with the other circuits.

According to the second embodiment, the transistor 32 is turned on, when the output signal of the AND gate 26 becomes low and hence the output signal of the comparator 27N becomes high. The second embodiment therefore provides the same advantage as the first embodiment.

### Third Embodiment

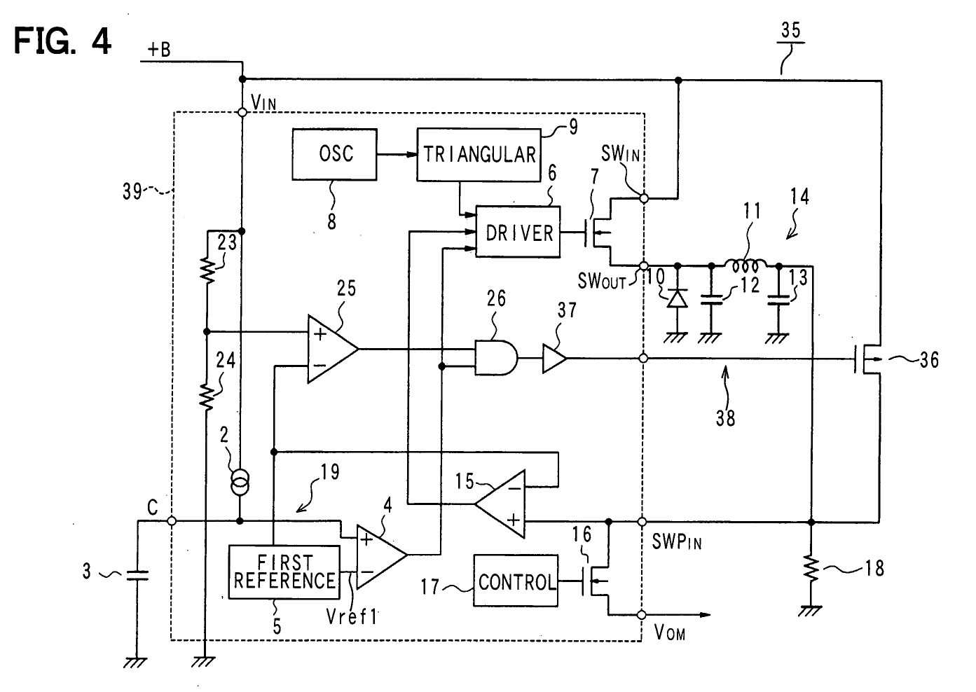

Referring to FIG. 4, a switching power circuit 35 is provided with a power bypass circuit (power bypass section) 38 in place of the power bypass circuit 22 of the first embodiment. In the power bypass circuit 38, a P-channel MOSFET (bypass transistor) 36 is provided in place of the transistor 29. The source of FET 36 is connected to receive the power source voltage +B and the drain of the same is connected to the input terminal SWPIN. A buffer 37 is provided in place of the comparator 27 and the reference voltage generator circuit 28. The power bypass circuit 38 other than FET 36 is integrated into a switching power IC 39 together with the other circuits.

According to the third embodiment, FET 36 is turned on, when the output signal of the AND gate 26 becomes low and hence the output signal of the buffer 37 also becomes low. The third embodiment therefore provides the same advantage as the first embodiment.

### Fourth Embodiment

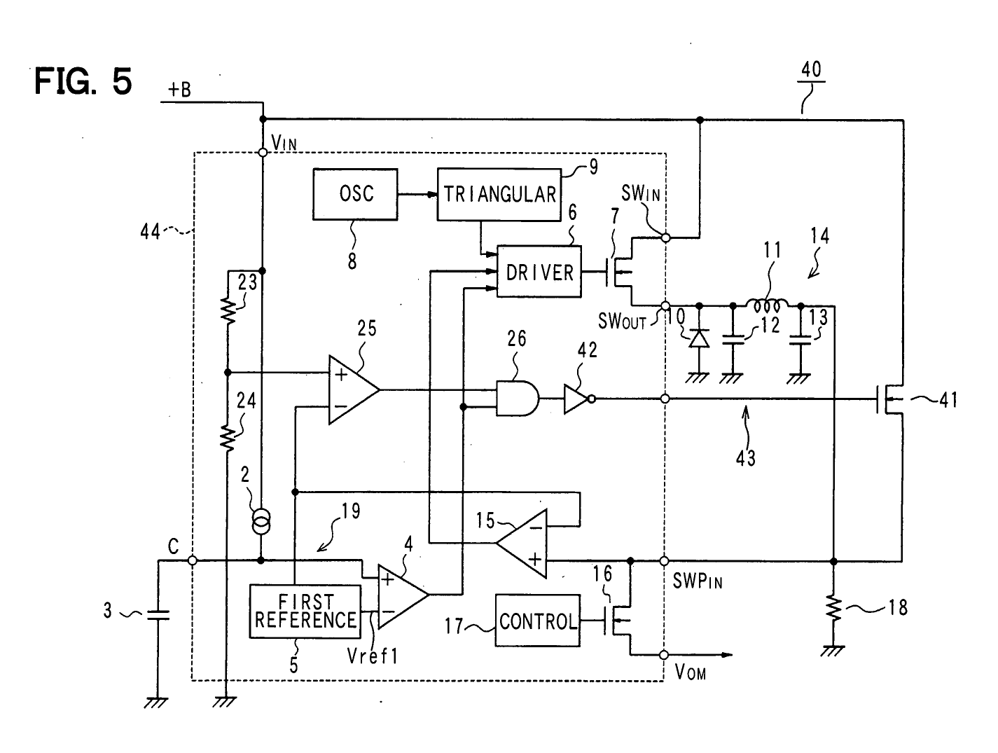

Referring to FIG. 5, a switching power circuit 40 is provided with a power bypass circuit (power bypass section) 43 in place of the power bypass circuit 38 of the third embodiment. In the power bypass circuit 43, a N-channel MOSFET (bypass transistor) 41 is provided in place of a P-channel MOSFET 36. The drain of FET 41 is connected to receive the power source voltage +B and the source of the same is connected to the input terminal SWPIN. A NOT gate 42 is provided in place of the buffer 37. The power bypass circuit 43 other than FET 41 is integrated into a switching power IC 44 together with the other circuits.

According to the fourth embodiment, FET 41 is turned on, when the output signal of the AND gate 26 becomes low and hence the output signal of the NOT gate 42 becomes high. The fourth embodiment therefore provides the same advantage as the third embodiment.

### Fifth to Eighth Embodiments

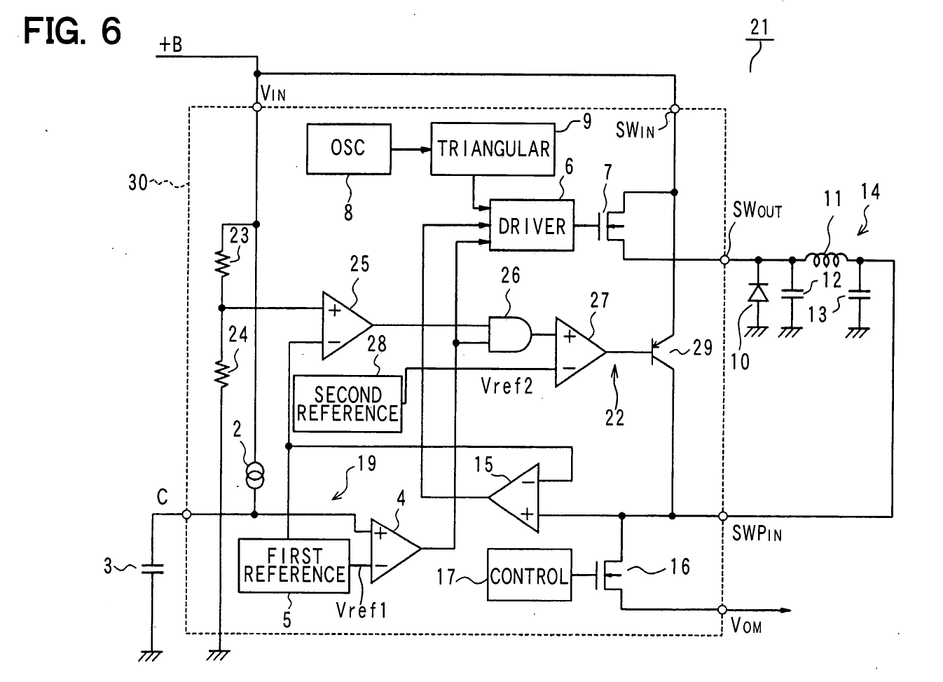

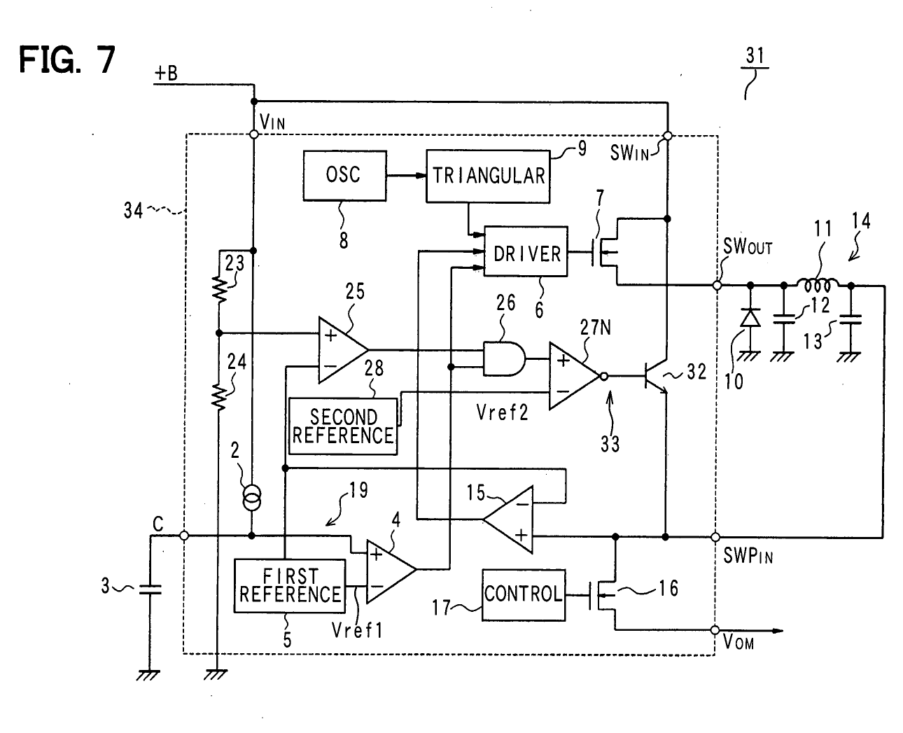

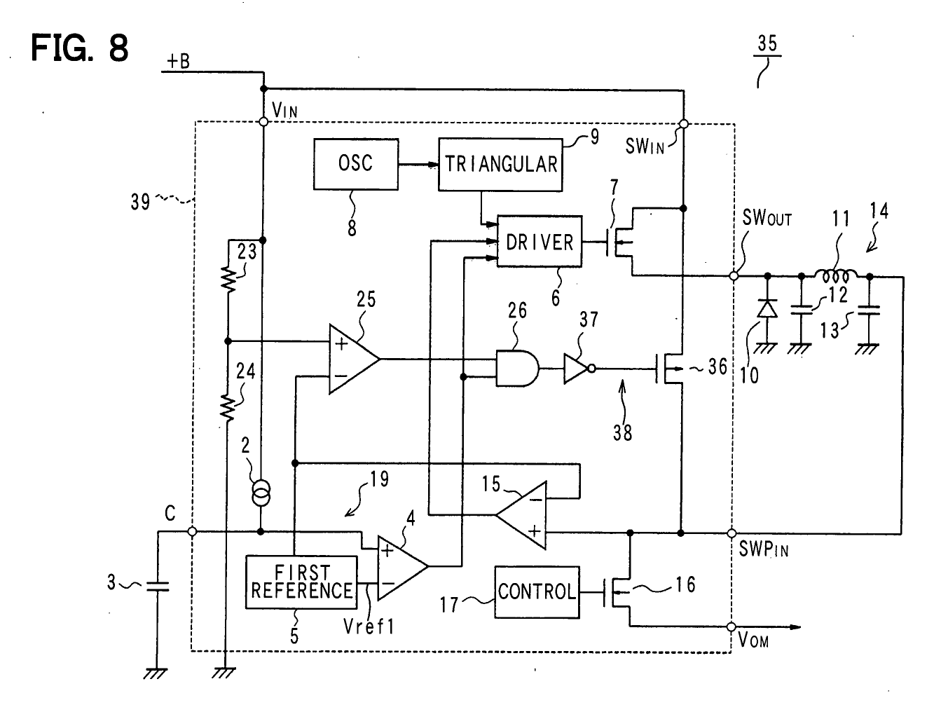

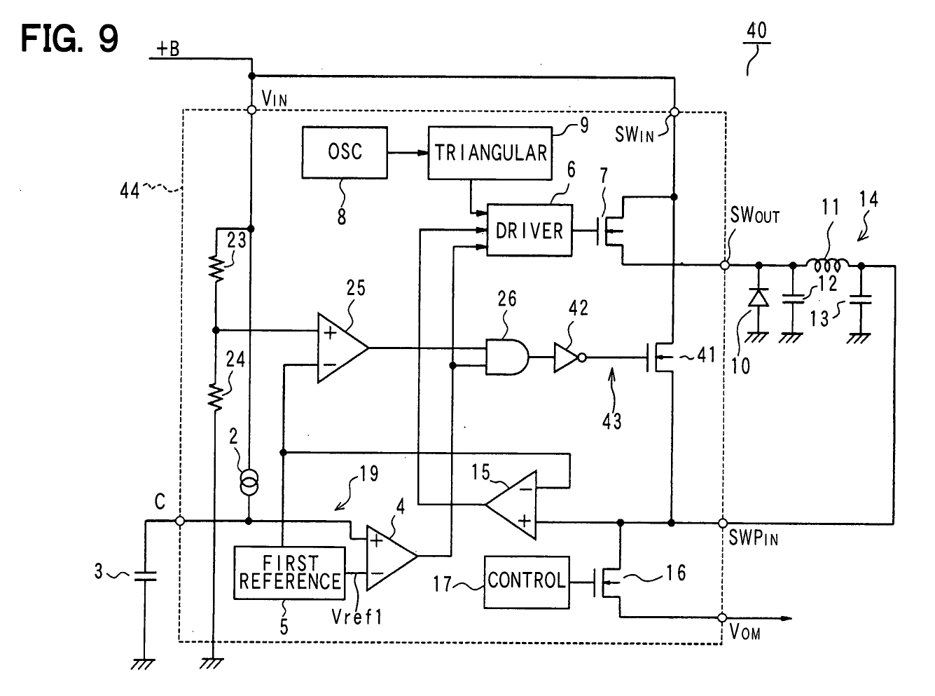

Referring to FIG. 6 to FIG. 9 showing the fifth to eighth embodiments, which correspond to the first to fourth embodiments, respectively, the bypass transistors (transistors 29, 32 and FETs 36, 41) are integrated in the switching power ICs 30, 34, 39 and 44 of the switching power circuit 21, 31, 35 and 40, respectively.

According to the fifth to eighth embodiments, the power bypass circuits 22, 33, 38 and 44 are formed on the same semiconductor substrates of the switching power ICs 30, 34, 39 and 44, respectively. As a result, the switching power circuits 21, 31, 33 and 40 can be provided in small size with the respective bypass circuits.

The present invention is not limited to the disclosed embodiments but may be modified as follows as a few examples.

FET 7 or 16 may be replaced with a N-channel MOSFET.

FET 16 and the control circuit 17 may be replaced with a constant voltage circuit and a three-terminal regulator.

The functional sections such as the resistors 23, 24, the comparator 25 and the AND gate 26, which are provided to counter a voltage drop after starting the supply of the power supply voltage, are optional and may be provided only when necessary.

The load, which is supplied with the main power from the switching power circuit, may be other than a microcomputer.

The soft start section may be configured with a counter and the like, which permits switching control when a predetermined period is counted after the supply of the power supply voltage is started.

The switching power circuit may be used in other than vehicles. For instance, it may be used in any devices, which uses a battery as an input power source or uses a DC power source that rectifies an AC voltage and smoothes the rectified voltage.

What is claimed is:

1. A switching power circuit comprising:
an electric power supply path connecting an output terminal and an input terminal, to which a power supply voltage is supplied from an external side;
a switching section interposed in the current supply path to switch on and off the power supply voltage;
a smoothing section for smoothing a switching output voltage produced by a switching operation of the switching section and producing an output terminal voltage, which is supplied to the output terminal;
a control signal generator section configured to generate a control signal to control the switching section so that the output terminal voltage produced by the smoothing section is regulated to a predetermined level;
a soft start section configured to start the switching operation of the switching section after an elapse of a predetermined period from a start of supply of the power supply voltage to the input terminal; and
a power bypass section configured to supply the power supply voltage to the output terminal by bypassing the switching section and the smoothing section until the power supply voltage reaches a predetermined reference voltage after the start of supply of the power supply voltage to the input terminal.

2. The switching power circuit according to claim 1, wherein the power bypass section is configured to bypass the switching section and the smoothing section until the power supply voltage of the electric power reaches the predetermined reference voltage again, when the power supply voltage falls below the predetermined reference voltage after reaching the predetermined reference voltage.

3. The switching power circuit according to claim 1, wherein the power bypass section includes:
a comparator section for comparing the power supply voltage of the input terminal with the predetermined reference voltage; and
a bypass transistor for rendering the input terminal and the output terminal conductive to each other in response to a comparison result of the comparator section.

4. The switching power circuit according to claim 1, wherein the power bypass section is formed on a same semiconductor substrate together with the switching section, the control signal generator section and the soft start section.

5. A method of producing an output power voltage to an output terminal from a power supply voltage supplied to an input terminal, the method comprising:
starting to charge a capacitor when supply of the power supply voltage to the input terminal is started;
comparing a voltage of the capacitor with a reference voltage;
starting a switching operation of a switching section in correspondence to the output power voltage at the output terminal when a result of comparison indicates that, the voltage of the capacitor has reached the reference voltage, the switching section producing a switching output voltage intermittently from the power supply voltage in correspondence to the switching operation;
smoothing the switching output voltage to produce the output power voltage at the output terminal; and
supplying the power supply voltage directly to the output terminal when the supply of the power supply voltage to the input terminal is started, so that the switching section starts the switching operation before the voltage of the capacitor reaches the reference voltage.
